(19) United States
(12) Patent Application Publication
(10) Pub. No.: US 2018/0108035 A1
(43) Pub. Date: Apr. 19, 2018

(54) METHOD AND SYSTEM FOR GROUPING OF CUSTOMERS FOR TARGETED ADVERTISING

(71) Applicant: MASTERCARD INTERNATIONAL INCORPORATED, Purchase, NY (US)

(72) Inventor: Rakesh Tiwari, Delhi (IN)

(21) Appl. No.: 15/783,450

(22) Filed: Oct. 13, 2017

(30) Foreign Application Priority Data
Oct. 14, 2016 (SG) 10201608642U

(51) Int. Cl. G06Q 30/02; G06Q 40/02; G06F 17/30

(52) U.S. Cl. CPC G06Q 30/0254; G06Q 30/0243; G06F 17/30867; G06F 17/30598; G06Q 40/02

(57) ABSTRACT

A system and method are provided for grouping customers from a pool of customers of a financial institution to subsequently receive advertisements. The method includes: retrieving, by a data collection module, identifier data of each customer in the pool of customers; retrieving, by the data collection module, financial information of each customer in the pool of customers based on the identifier data; determining, by an affordability condition determination module and for each customer, an affordability condition based on the financial information; determining, by a price parameter determination module, a price parameter for each advertisement; comparing, by an advertisement comparison module and for each advertisement, the price parameter against the affordability condition of each customer; and allocating, by a customer allocation module and for each advertisement, customers into a group of customers to subsequently receive the advertisement, if the price parameter satisfies the affordability conditions of the customers.

### TECHNICAL FIELD

The present disclosure generally relates to a method and system for grouping of customers for targeted advertising. More particularly, the present disclosure describes various embodiments of a method and system for grouping of customers of a financial institution (e.g. bank) to subsequently receive advertisements or advertisement/advertising/promotion/marketing materials (e.g. vouchers, offers, discounts, etc.).

### BACKGROUND

Advertising may be defined as a form of marketing communication for promoting or selling a product and/or service. Vendors such as financial institutions, e.g. banks and credit card issuers, often rely on advertising channels to attract customers to purchase their financial products or to card issuers to promote discounts and rebates, such as for spending above a minimum amount on their credit cards.

Traditional advertisements may tend to be overly generic and may not necessarily pertain to a particular customer's interests or needs. Some statistics estimate that the response rate for advertising channels such as emails, direct mailers, and even social media tend to be low, with a hit rate of around 0.5%. Some vendors rely on more targeted advertising such as tracking of a customer's internet or online behaviour to determine the customer's interests. Specific advertisement materials may be selected and communicated to the customer. For some of these vendors, particularly for the financial institutions, are focused more on their profitability, i.e. how much they can earn from customers. Some advertisements from financial institutions may be for financial products that the financial institution believes the customers need, i.e. finding a match between the customer's unmet needs and the financial products. These advertisements are created based on customer responses to marketing models and surveys.

However, the advertisements target customers based on customer demographics, i.e. target specific sectors of the customer population. The advertisements to not take into account on the individuality of each customer, such as the profile and financial ability of any one customer. For example, an advertisement from a vendor may offer a cashback rebate for spending above a minimum amount. The minimum amount would apply to every customer within the targeted sectors or even the entire customer population. The advertisement does not consider whether every customer within the sector/population can afford the minimum spending. Thus, one problem associated with such demographic selection or grouping of customers for receiving advertisements is that there appears to be a gap between the financial ability of a customer and the product or promotion offered by an advertisement.

Therefore, in order to address or alleviate at least one of the aforementioned problems and/or disadvantages, there is a need to provide a method and system for grouping of customers to subsequently receive advertisements, in which there is at least one improved feature over the aforementioned prior art.

### SUMMARY

According to an aspect of the present disclosure, there is computerized method implemented on a computing system of a financial institution for grouping of customers from a pool of customers of the financial institution to subsequently receive advertisements, the computing system of the financial institution implementing the method, and a non-transitory computer-readable medium storing computer-readable instructions that, when executed, cause a processor to perform steps of the method. The method comprises: retrieving, by a data collection module of the computing system and from a customer database of the financial institution, identifier data of each customer in the pool of customers; retrieving, by the data collection module and from at least one financial database, financial information of each customer in the pool of customers based on the identifier data; determining, by an affordability condition determination module of the computing system and for each customer in the pool of customers, an affordability condition based on the financial information; determining, by a price parameter determination module of the computing system, a price parameter for each advertisement; comparing, by an advertisement comparison module of the computing system and for each advertisement, the price parameter against the affordability condition of each customer; and allocating, by a customer allocation module of the computing system and for each advertisement, customers into a group of customers to subsequently receive the advertisement, if the price parameter satisfies the affordability conditions of the customers.

An advantage of the above aspects of the present disclosure is that by considering the affordability conditions of customers and matching or comparing them against the costs of advertisements, financial intuitions can help to better target the appropriate group of customers to receive the advertisements. Only customers who are assessed to be able to afford the cost of products/services offered by the advertisements will be targeted to receive the advertisements. There may also be a greater probability for customers who receive the advertisements to purchase the products/services offered as they know they are able to afford them and the hit rate of the advertisements would consequently increase. The present disclosure thus provides an improved framework for financial institutions, as well as for vendors and merchants, to improvise their advertising or targeting strategy.

A method and system for grouping of customers to subsequently receive advertisements according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of a system for implementation of a method for grouping of customers to subsequently receive advertisements, in accordance with an embodiment of the present disclosure.

FIG. 2 is a block diagram illustration of the technical architecture of a computing system, in accordance with an embodiment of the present disclosure.

FIG. 3 is a flowchart illustration of a method implemented on a computing system for grouping of customers to subsequently receive advertisements, in accordance with an embodiment of the present disclosure.

FIG. 4 is a flowchart illustration of a method implemented on a computing system for grouping of customers to subsequently receive advertisements, in accordance with another embodiment of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “/” in a figure or associated text is understood to mean “and/or” unless otherwise indicated. As used herein, each of the terms “set”, “group”, “pool”, and “population” corresponds to or is defined as a non-empty finite organization of elements that mathematically exhibits a cardinality of at least one (e.g. a set as defined herein can correspond to a unit, singlet, or single element set, or a multiple element set), in accordance with known mathematical definitions. The recitation of a particular numerical value or value range herein is understood to include or be a recitation of an approximate numerical value or value range.

For purposes of brevity and clarity, descriptions of embodiments of the present disclosure are directed to a method and system for grouping of customers to subsequently receive advertisements, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

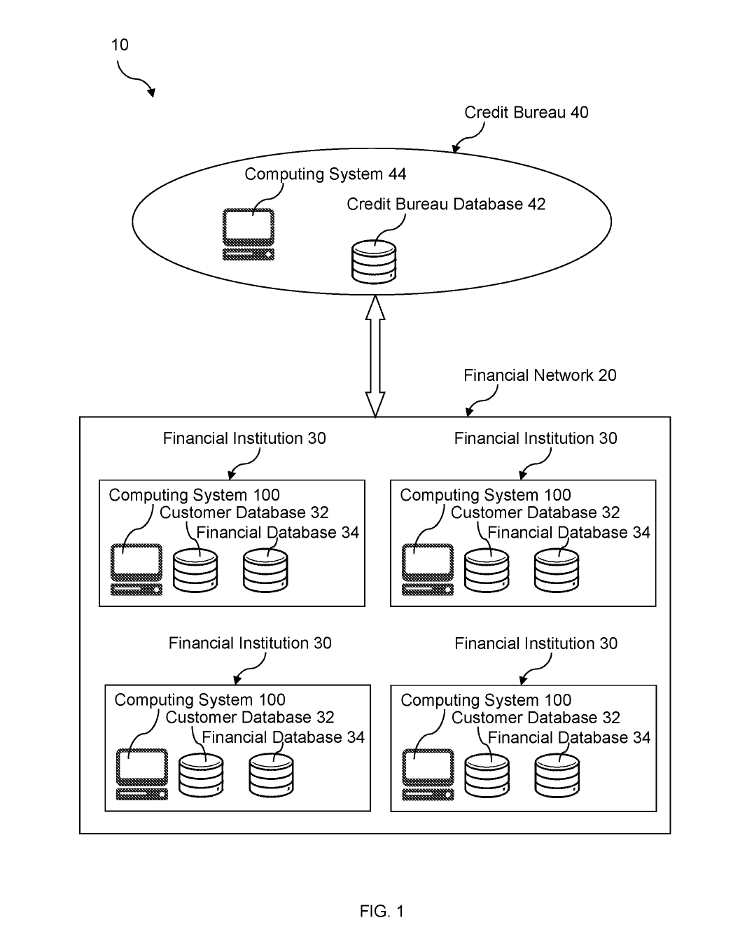

In representative or exemplary embodiments of the present disclosure, there is provided a system 10 as illustrated in FIG. 1. The system 10 comprises a financial network 20 of financial institutions 30. Each financial institution 30 may have one or more customers, i.e. a population of customers, and each customer may be a customer of one or more financial institutions 30. A financial institution 30 may include, but is not limited to, a bank or credit card issuer.

A customer of a financial institution 30 may be defined as an individual who is in a business relationship with the financial institution 30, such as from purchases of financial products from the financial institution 30. The financial products may include, but are not limited to, payment cards, credit cards, debit cards, or any payment vehicle in general. The term “payment vehicle” may refer to any suitable cashless payment mechanism, such as a credit card, a debit card, a prepaid card, a charge card, a membership card, a promotional card, a frequent flyer card, an identification card, a gift card, and/or any other payment cards that may hold payment card information (e.g. details of user account or payment card) and which may be stored electronically on a mobile device.

Each financial institution 30 comprises a customer database 32 for recording information of every customer of the financial institution 30. The information in the customer database 32 may include identifier data, profile and/or demographic information of the customers. Each financial institution 30 further comprises a financial database 34 for recording financial information of the customers. It may be appreciated that the financial information retrieved from the financial database 34 refers to institution-specific financial information, i.e. financial information that is specific or relevant to the business relationship between the customer and the financial institution 30 only. It may also be appreciated that the customer database 32 and financial database 34 may be distinct from each other, or integrated together as a single database.

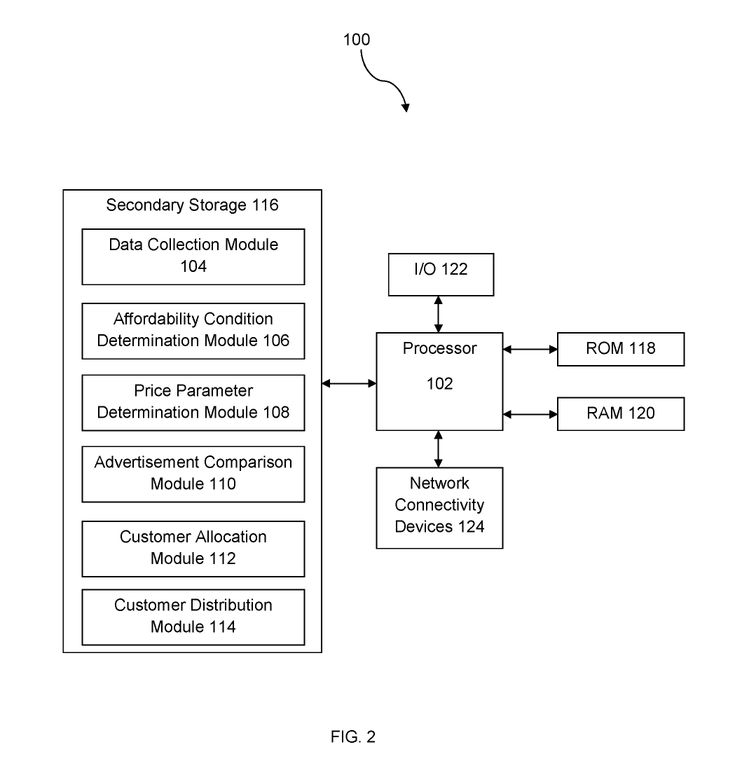

Further, with additional reference to FIG. 2, each financial institution 30 comprises a computing system 100 having a processor 102, a data collection module/component 104, an affordability condition determination module/component 106, a price parameter determination module/component 108, an advertisement comparison module/component 110, a customer allocation module/component 112, a customer distribution module/component 114, and a memory or a set of memory devices configured to store computer-readable instructions. The computing system 100 controls and manages operations of the financial institution 30, and is communicatively linked to the customer database 32 and financial database 34 for transmitting and receiving data therewith. The customer database 32 and financial database 34 may reside on the computing system 100, or alternatively on a remote computer communicatively linked to the computing system 100.

The following is a description of the technical architecture of the computing system 100 of the financial institution 30 with reference to FIG. 2.

FIG. 2 illustrates a block diagram showing a technical architecture of the computing system 100. The technical architecture includes a processor 102 (which may be referred to as a central processor unit or CPU) that is in communication with memory devices including secondary storage 116 (such as disk drives or memory cards), read only memory (ROM) 118, and random access memory (RAM) 120. The processor 102 may be implemented as one or more CPU chips. The technical architecture further comprises input/output (I/O) devices 122, and network connectivity devices 124.

The secondary storage 116 is typically comprised of one or more memory cards, disk drives, tape drives, or other storage devices and is used for non-volatile storage of data and as an over-flow data storage device if RAM 120 is not large enough to hold all working data. The secondary storage 116 may be used to store programs which are loaded into RAM 120 when such programs are selected for execution.

The secondary storage 116 has processing modules or components comprising non-transitory instructions operative by the processor 102 to perform various operations and steps according to various embodiments of the present disclosure. The processing components of the secondary storage 116 may include a data collection module/component 104, an affordability condition determination module/component 106, a price parameter determination module/component 108, an advertisement comparison module/component 110, a customer allocation module/component 112, a customer distribution module/component 114, and a memory or a set of memory devices comprising non-transitory instructions operative by the processor 102 to perform the various operations and steps. Non-transitory computer-readable media include all computer-readable media, with the sole exception being a transitory propagating signal per se.

As depicted in FIG. 2, the modules 104, 106, 108, 110, 112, and 114 are distinct modules which perform respective functions implemented by the computing system 100. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the modules 104, 106, 108, 110, 112, and 114 is described herein, these may alternatively be implemented as one or more hardware modules (such as field-programmable gate array(s) or application-specific integrated circuit(s)) comprising circuitry which implements equivalent functionality to that implemented in software. The ROM 118 is used to store instructions and perhaps data which are read during program execution. The secondary storage 116, the ROM 118, and/or the RAM 120 may be referred to in some contexts as computer-readable storage media and/or non-transitory computer-readable media.

The I/O devices 122 may include printers, video monitors, liquid crystal displays (LCDs), plasma displays, touch screen displays, keyboards, keypads, switches, dials, mice, track balls, voice recognizers, card readers, paper tape readers, and/or other well-known input devices.

The network connectivity devices 124 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 124 may enable the processor 102 to communicate with the Internet or one or more intranets. With such a network connection, it is contemplated that the processor 102 might receive information from the network, or might output information to the network in the course of performing various operations or steps according to various embodiments of the present disclosure. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered as or part of the secondary storage 116), flash drive, ROM 118, RAM 120, or the network connectivity devices 124. While only one processor 102 is shown, multiple processors may be present. Thus, while instructions may be discussed as executed by a processor, the instructions may be executed simultaneously, serially, or otherwise executed by one or multiple processors.

It should be appreciated that the technical architecture of the computing system 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the computing system 100, at least one of the CPU 102, the ROM 118, and the RAM 120 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by well-known design rules.

Referring back to FIG. 1, the system 10 further comprises a credit bureau 40. The credit bureau 40 may alternatively be known as a consumer/customer reporting agency in the United States, a credit reference agency in the United Kingdom, a credit reporting body in Australia, and a credit information company in India. The credit bureau 40 is communicable with and collects financial information from the financial network 20. More specifically, the credit bureau 40 collects financial information from various financial sources within the financial network 20, e.g. multiple financial institutions 30, and derives customer credit information on individual customers. If a customer is associated with, e.g. has business relationships with or is a customer of, multiple financial institutions 30, then each financial institution 30 would record institution-specific financial information of the customer on the respective financial databases 34. The credit bureau 40 collects all the financial information of the customer from the financial databases 34 and records them as consolidated financial information on a financial database of the credit bureau 40, e.g. a credit bureau database 42. The credit bureau 40 may include a computing system 44 for controlling and managing operations of the credit bureau 40, and is communicatively linked to the credit bureau database 42 for transmitting and receiving data therewith. The credit bureau database 42 may reside on the computing system 44 of the credit bureau 40, or alternatively on a remote computer communicatively linked to the computing system 44 of the credit bureau 40.

In various embodiments, the computing system 100 of each financial institution 30 is configured or operative for performing a method of grouping of customers of the financial institution 30 to subsequently receive advertisements.

### First Embodiment

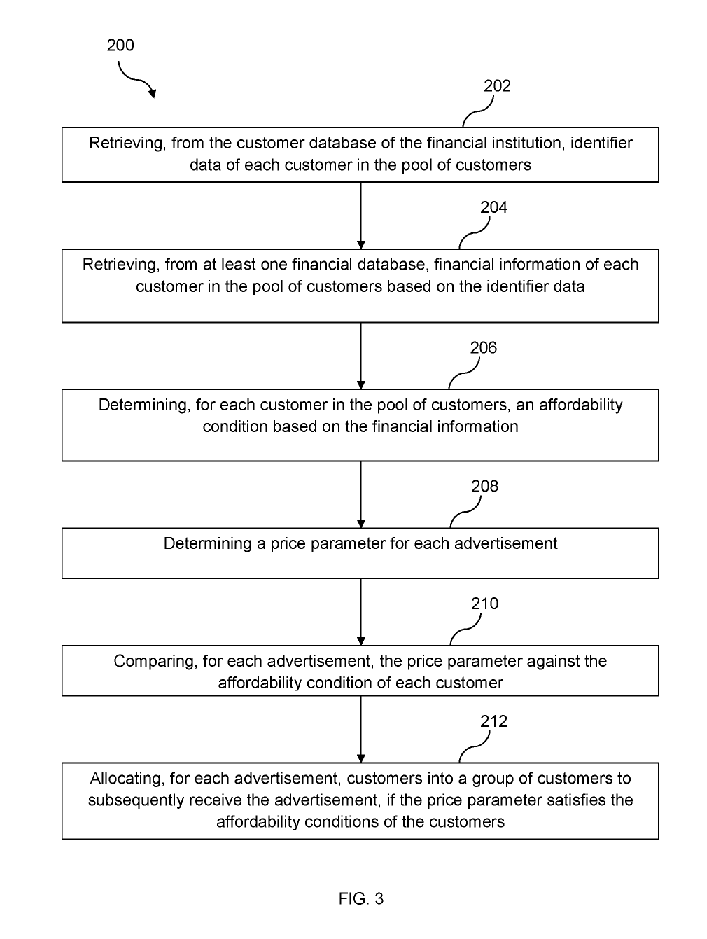

In a first embodiment which is described with reference to FIG. 3, the computing system 100 of a financial institution 30 is configured or operative for performing a method 200 of grouping of customers of the financial institution 30 to subsequently receive advertisements. The customers are grouped from a pool of customers of the financial institution 30. The pool of customers may represent a whole population of customers of the financial institution 30, or may alternatively represent a set or subset of customers derived from the population of customers.

The method 200 comprises a step 202 of retrieving, such as by the data collection module 104 or other module/component of the computing system 100, and from the customer database 32 of the financial institution 30, identifier data of each customer in the pool of customers. The identifier data of each customer may include, but is not limited to, the customer's full name, email address, phone number, address, nationality, and identification number (e.g. national ID, driver's licence ID, or passport number). The identifier data is intended to distinguish each customer within the pool of customers or even the population of customers.

The method 200 further comprises a step 204 of retrieving, such as by the data collection module 104 or other module/component of the computing system 100, and from at least one financial database, financial information of each customer in the pool of customers based on the identifier data. For example, the step 204 comprises retrieving financial information of each customer in the pool of customers from the financial database 34 of the financial institution 30. Alternatively or additionally, the step 204 comprises retrieving consolidated financial information of each customer from the financial database or credit bureau database 42 of the credit bureau 40.

In this first embodiment, the step 204 comprises retrieving consolidated financial information of each customer from the credit bureau database 42. The consolidated financial information of each customer comprises a collection or an aggregation of financial information from multiple financial sources within the financial network 20, including at least the financial institution 30 according to the method 200. The consolidated financial information may include current credit/debit data of the customer aggregated from multiple financial sources associated with the customer. For example, the current credit/debit data may be derived from financial sources, such as but not limited to, financial institutions 30, tax authorities, property/housing authorities, vehicle companies, credit card debts, and credit loan companies. More broadly, the consolidated financial information may be derived from the assets, liabilities, and equities of the customer, and may provide an overall credit score or rating of the customer, which may be considered as being representative of his/her financial status.

The method 200 further comprises a step 206 of determining, by the affordability condition determination module 106 or other module/component of the computing system 100, and for each customer in the pool of customers, an affordability condition based on the financial information, or more specifically, the consolidated financial information from the credit bureau database 42. The consolidated financial information may provide an overall credit score of the customer and may comprise data from a number of financial variables associated with the customer. For example in the United States, some banks or credit card issuers use the FICO score as the overall credit score of the customer, wherein the FICO score is derived from multiple financial variables (e.g. FICO-100 score derived from 100 financial variables). The financial variables contained in the consolidated financial information of the customer may include but is not limited to the following.

Income/salary;

Total credit balance across all financial products (e.g. credit cards) of the customer (for every financial institution 30 within the financial network 20);

Total savings balance across all accounts of the customer (for every financial institution 30 within the financial network 20);

Remaining mortgage balance; and

Total loans/debts balance.

The overall credit score of the customer is calculated by the credit bureau 40 based on the consolidated financial information in the credit bureau database 42. Similarly, in the step 206, an affordability condition of each customer is calculated based on the same consolidated financial information, such as by the affordability condition determination module 106 or other module/component of the computing system 100 of the financial institution 30. The calculation of the affordability conditions is based on algorithms predetermined by the financial institution 30. The algorithms may vary and differ between different financial institutions 30 within the financial network 20. For example, different weightings may be applied to different financial variables, and/or each financial variable may have a variable weight, depending on various conditions such as risk profiles of the financial institutions 30. The weightings may define whether the affordability condition is a price range or a price point.

It may be appreciated that, alternatively, the affordability conditions of the customer may be determined, calculated, or estimated from financial information obtained from the financial database 34 of the financial institute 30, such as if the customer only has financial accounts with one financial institute, i.e. the financial institute 30.

The affordability condition of each customer may represent a price range (e.g. $100 to $500) or a price point (e.g. $1,000). The price range/point is indicative of the amount of money that the customer may be able to pay for product(s)/service(s) such as those offered in advertisement(s) subsequently received by the customer. Based on the affordability conditions, the pool of customers may be distributed, such as by the customer allocation module 112 or other module/component of the computing system 100, into a plurality of affordability groups. Each affordability group may be associated with one or more affordability conditions of the customers. Thus, if some customers have different affordability conditions that differ slightly, the customers may be grouped together within the same affordability group. For example, in one affordability group, there may be customers with affordability conditions of price ranges $100 to $300, $150 to $200, $150 to $250, and/or $200 to $300. The affordability groups thus provides for broader segregation of the pool of customers based on their affordability conditions.

According to the method 200, the grouping of customers is intended to subsequently receive advertisements from the financial institution 30. The financial institution 30 may thus communicate advertisements on their financial products to the customers, or may communicate advertisements on behalf of other vendors or merchants to the customers. The advertisements may be stored on and retrieved from an advertisement database. The advertisement database may reside on the computing system 100, or alternatively on a remote computer communicatively linked to the computing system 100. Yet alternatively, each vendor or merchant may provide advertisements independently to the financial institution 30 for communication to the customers on behalf of the vendor or merchant.

The method 200 further comprises a step 208 of determining, such as by the price parameter determination module 108 or other module/component of the computing system 100, a price parameter for each advertisement. An advertisement may comprise a promotional/offer price or price range for a product or service, an average promotional/offer price or price range for a set/group of products or services, or a minimum amount a customer has to spend in order to qualify or be eligible for certain promotional rebates, e.g. monetary or percentage cashback. The price parameter may thus represent the promotional/offer price or price range or the minimum spending amount. More broadly, the price parameter of each advertisement may represent a price range (e.g. $100 to $500) or a price point (e.g. $1,000).

As an illustration, an advertisement may offer several products that are related or complementary to one another, such as products based on a common theme, e.g. traveling. There may be an offer price associated with each product. For example, the advertisement may offer Product A at $100, Product B at $200, and Product C at $180. The price parameter may be calculated as a price point, which may be the average or mean of the offer prices, i.e. $160. Alternatively, the price parameter may be calculated as a price range, i.e. $100 to $200.

The method 200 further comprises a step 210 of comparing, by the advertisement comparison module 110 or other module/component of the computing system 100, and for each advertisement, the price parameter against the affordability condition of each customer. Specifically, for each advertisement, the price parameter of the advertisement is matched or compared against the affordability condition of a customer in the pool of customers, and is repeated until all the customers in the pool of customers have been matched/compared.

The method 200 further comprises a step 212 of allocating, such as by the customer allocation module 112 or other module/component of the computing system 100, and for each advertisement, customers into a group of customers to subsequently receive the advertisement, if the price parameter satisfies the affordability conditions of the customers. In the step 210, the affordability conditions of the customers are compared against the price parameter of the advertisement. From the step 210, customers whose affordability conditions satisfy the price parameter of the advertisement may be determined. According to the step 212, these customers are allocated into the group of customers to subsequently receive the advertisement.

For example, an advertisement may offer a product with the price parameter being a price range of $300 to $500, and a customer may have the affordability condition being a price range of $800 to $1,000 or a price point of $900. The customer would be able to afford the product offered in the advertisement. The price parameter satisfies the affordability condition, and the customer would be allocated into a group of customers to subsequently receive the advertisement. The affordability condition may be considered to have been satisfied by the price parameter if the price parameter falls within or below 100% of the affordability condition, i.e. the customer is able to afford the advertisement. In some cases, it may be possible for the financial institution 30 to vary the percentage accordingly, such as depending on the risk profile of the customers. Customers who are risk averse may have a tighter affordability condition, e.g. the price parameter must be within or below 50% of the affordability condition. The financial institution 30 may also vary the percentage depending on the probability of the customer defaulting on the credit in future.

Conversely, if the customer has the affordability condition being a price range of $100 to $200 or a price point of $150, the customer would not be able to afford the product offered in the advertisement. The price parameter does not satisfy the affordability condition as price parameter is beyond 100% of the affordability condition, and the customer would not be grouped into a group of customers to subsequently receive the advertisement. The comparison and allocation steps are repeated for all the customers in the pool of customers.

It may be appreciated that there may be multiple advertisements and correspondingly multiple groups of customers. As such, the method 200 may further include allocating, such as by the customer allocation module 112 or other module/component of the computing system 100, all the customers in the pool of customers into a plurality of groups of customers, such that the pool of customers is distributed into the plurality of groups of customers. Each group of customers is associated with an advertisement for subsequent communication to each customer in the group. Thus, according to the method 200, each customer in the pool of customers may be allocated into a group of customers to subsequent receive an advertisement, and the grouping of customers is repeated to form groups of customers for all advertisements, wherein each advertisement is associated with one group of customers.

The affordability condition of a customer may allow the customer to be grouped into one or more groups of customers, such as if the customer has high liquidity or a considerable amount of money to spend. Thus, each customer in the pool of customers may be grouped into one or more groups of customers to subsequently receive the advertisement(s) associated with the one or more groups of customers. For example, the method 200 may further include allocating, such as by the customer allocation module 112 or other module/component of the computing system 100, customers into a second group of customers after being allocated into a first group of customers to subsequently receive the advertisements associated with the first and second groups of customers, if the price parameters of the advertisements satisfy the affordability conditions of the customers. It would be readily understood by the skilled person that a customer may be allocated into all of a first group, second group, third group, or even more groups of customers.

However, some customers do not prefer to receive multiple advertisements if they are allocated into multiple groups of customers, and the algorithms may provide for selection of only one advertisement to be communicated to the customer. If customers can be allocated into a first and a second group of customers, the method 200 may further include allocating, such as by the customer allocation module 112 or other module/component of the computing system 100, customers into one of the first and second groups of customers. In addition, the one of the first and second groups of customers which the customers are allocated to may be associated with the highest price parameter of the advertisement. For example, if there are two advertisements (e.g. one offering a product at $500 and another offering a product at $1,000) associated with two groups of customers and the customer can be allocated into both groups because the price parameters of both advertisements satisfy the affordability condition of the customer (e.g. he/she has an affordability condition of $1,000 to $1,500 and is able to afford the products offered by both advertisements), the customer would be allocated into the group of customers associated with the advertisement with the highest price parameter (i.e. the advertisement offering the $1,000 product). This would ensure that the customer receives the highest-value advertisement which can potentially provide the financial institution 30 and/or the vendor of the advertisement with maximum profitability if the customer proceeds to purchase the $1,000 product.

Consideration of the affordability conditions of customers and comparing them against the costs of advertisements help to better target the appropriate group of customers to receive the advertisements. Only customers who are assessed to be able to afford the cost of products/services offered by the advertisements will be targeted to receive the advertisements. It would not be an effective advertising strategy if customers who could not afford the products/services still receive the advertisements. There may also be a greater probability for customers who receive the advertisements to purchase the products/services offered as they know they are able to afford them. For the financial institutions 30 and/or vendors providing the advertisements, the hit rate of the advertisements would consequently increase. The present disclosure thus provides an improved framework for financial institutions 30, as well as for vendors and merchants, to improvise their advertising or targeting strategy.

A detailed example of the first embodiment described above with reference to FIG. 3 is described in Example 1 below. For simplicity, the price parameters of the advertisements and the affordability conditions of the customers are illustrated as price points.

### EXAMPLE 1

In this example, a pool of customers of a financial institution 30 may consist of 20 customers. The identifier data and consolidated financial information of each customer are retrieved according to the steps 202 and 204 of the method 200. An affordability condition of each customer is then calculated based on the consolidated financial information according to the step 206. Table 1 below illustrates a sample number of customers and how the affordability condition is calculated.

TABLE 1

| | Financial Variable | | | |
|---|---|---|---|---|
| | | Monthly | Remaining | |
| | Monthly | Mortgage | Credit Card | Affordability |
| Customer | Savings Balance | Installment | Balance | Condition |
| 1 | $10,000 | $1,000 | $2,000 | $4,250 |
| 2 | $7,000 | $2,000 | $3,000 | $2,250 |
| 3 | $6,000 | $3,000 | $3,000 | $1,500 |
| 4 | $2,000 | $3,000 | $3,000 | ($500) |

Notably, Customer 4 has an affordability condition of a negative price point, i.e. the customer is overall in debt and would not be able to afford any product offered in the advertisements. The affordability conditions are calculated according to algorithm(s) predetermined by the financial institution 30. An illustrative algorithm is shown as:

Affordability Condition=(0.5×X)−(0.25×Y)−(0.25×Z), wherein X refers to the monthly savings balance, Y refers to the monthly mortgage installment, and Z refers to the remaining credit card balance.

In this example, there may be 5 advertisements identified as P1 to P5. Each of the advertisements P1 to P5 has a price parameter indicating an average price of products offered by the advertisement. The price parameters of the advertisements are illustrated as follows.

a. P1—$500

b. P2—$1,000

c. P3—$1,500

d. P4—$2,000

e. P5—$3,000

Table 2 below is an illustration of the affordability conditions of all 20 customers and the advertisements (P1 to P5) that each customer would be able to afford, i.e. for the products offered by the advertisements. Table 2 also shows the distribution of the customers into affordability groups to more broadly segregate the pool of customers. Some customers may be eligible to receive more than one advertisement. It may be appreciated that the advertisements can be selected such that the customers receive only one advertisement of the highest value which the customer can afford. Table 2 also illustrates the highest-value advertisements among the affordable advertisements for each customer.

TABLE 2

| | Affordability | Affordability | Affordable | Highest-value |
|---|---|---|---|---|
| Customer | Condition | Group | Advertisements | Advertisement |
| 1 | $4,250 | A5 | P1, P2, P3, P4, P5 | P5 |
| 2 | $2,250 | A3 | P1, P2, P3, P4 | P4 |
| 3 | $1,500 | A2 | P1, P2, P3 | P3 |
| 4 | ($500) | A1 | None | None |
| 5 | $750 | A1 | P1 | P1 |
| 6 | $5,000 | A5 | P1, P2, P3, P4, P5 | P5 |
| 7 | $3,000 | A4 | P1, P2, P3, P4, P5 | P5 |
| 8 | $800 | A1 | P1 | P1 |
| 9 | $750 | A1 | P1 | P1 |
| 10 | $1,300 | A2 | P1, P2 | P2 |
| 11 | $1,800 | A2 | P1, P2, P3 | P3 |
| 12 | $2,600 | A3 | P1, P2, P3, P4 | P4 |
| 13 | $4,500 | A5 | P1, P2, P3, P4, P5 | P5 |
| 14 | $2,100 | A3 | P1, P2, P3, P4 | P4 |
| 15 | $2,900 | A3 | P1, P2, P3, P4 | P4 |
| 16 | $3,100 | A4 | P1, P2, P3, P4, P5 | P5 |
| 17 | $3,700 | A4 | P1, P2, P3, P4, P5 | P5 |
| 18 | $500 | A1 | P1 | P1 |
| 19 | $200 | A1 | None | None |
| 20 | $100 | A1 | None | None |

The affordability groups A1 to A5 represent the affordability conditions as follows.

a. A1—Below $1,000

b. A2—From $1,000 to below $2,000

c. A3—From $2,000 to below $3,000

d. A4—From $3,000 to below $4,000

e. A5—$4,000 and above

Table 3 below is an illustration of the customers allocated into the groups of customers associated with the advertisements. There are two scenarios for the allocation of customers—the first scenario for customers who are to receive multiple advertisements, and the second scenario for customers who are to receive one advertisement which is the highest-value advertisement.

TABLE 3

| | Multiple Advertisements | | Highest-value Advertisement | |
|---|---|---|---|---|
| | | Number of | | Number of |
| Advertise- | Allocated | Allocated | Allocated | Allocated |
| ment | Customers | Customers | Customers | Customers |
| P1 | Customers 1 to | 17 | Customers 5, 8, | 4 |
| | 3, and 5 to 18 | | 9, and 18 | |
| P2 | Customers 1 to | 13 | Customer 10 | 1 |
| | 3, 6, 7, and 10 to | | | |
| | 17 | | | |
| P3 | Customers 1 to | 12 | Customers 3 and | 2 |
| | 3, 6, 7, and 11 to | | 11 | |
| | 17 | | | |
| P4 | Customers 1, 2, | 10 | Customers 2, 12, | 4 |
| | 6, 7, and 12 to | | 14, and 15 | |
| | 17 | | | |
| P5 | Customers 1, 6, | 6 | Customers 1, 6, | 6 |
| | 7, 13, 16, and 17 | | 7, 13, 16, and 17 | |

According to Table 3, if customers can receive multiple advertisements, then there are 17 customers allocated to receive advertisement P1, 13 customers allocated to receive advertisement P2, 12 customers allocated to receive advertisement P3, 10 customers allocated to receive advertisement P4, and 6 customers allocated to receive advertisement P5. If customers can receive only the highest-value advertisement, there are 4 customers allocated to receive advertisement P1, 1 customer allocated to receive advertisement P2, 2 customers allocated to receive advertisement P3, 4 customers allocated to receive advertisement P4, and 6 customers allocated to receive advertisement P5. Thus, each cell in the column “Number of Allocated Customers” in Table 3 represents a group of customers associated with the “Advertisement” of the same row.

Tables 4A and 4B below illustrate the distribution of customers across the advertisements P1 to P5 and affordability groups A1 to A5. The distribution of customers in Table 4A is shown in relation to the customers being able to receive multiple advertisements (i.e. the first scenario), and the distribution of customers in Table 4B is shown in relation to the customers being able to receive one advertisement which is the highest-value advertisement (i.e. the second scenario).

TABLE 4A

| | Advertisement | | | | |
|---|---|---|---|---|---|
| Affordability | P1 | P2 | P3 | P4 | P5 |
| Group | ($500) | ($1,000) | ($1,500) | ($2,000) | ($3,000) |
| A1 (<$1000) | 4 | 0 | 0 | 0 | 0 |
| A2 ($1000 to | 3 | 3 | 2 | 0 | 0 |
| <$2000) | | | | | |
| A3 ($2000 to | 4 | 4 | 4 | 4 | 0 |
| <$3000) | | | | | |
| A4 ($3000 to | 3 | 3 | 3 | 3 | 3 |
| <$4000) | | | | | |
| A5 (≥$4000) | 3 | 3 | 3 | 3 | 3 |

TABLE 4B

| | Advertisement | | | | |
|---|---|---|---|---|---|
| Affordability | P1 | P2 | P3 | P4 | P5 |
| Group | ($500) | ($1,000) | ($1,500) | ($2,000) | ($3,000) |
| A1 (<$1000) | 4 | 0 | 0 | 0 | 0 |
| A2 ($1000 to | 0 | 1 | 2 | 0 | 0 |
| <$2000) | | | | | |
| A3 ($2000 to | 0 | 0 | 0 | 4 | 0 |
| <$3000) | | | | | |
| A4 ($3000 to | 0 | 0 | 0 | 0 | 3 |
| <$4000) | | | | | |
| A5 (≥$4000) | 0 | 0 | 0 | 0 | 3 |

In Tables 4A and 4B, each column represents a group of customers associated with the advertisement for the column. In Table 4A, a customer may be allocated into one or more groups of customers. In Table 4B, a customer may be allocated into only one group of customers, i.e. the one associated with the highest-value advertisement. Each column or group of customers may be divided according to the affordability groups, i.e. into multiple sub-groups of customers. Accordingly, each cell in Tables 4A and 4B represents a sub-group of customers, such that each sub-group of customers is defined by one advertisement and one affordability group. After grouping of customers according to the method 200, the advertisements may be subsequently communicated to the respective groups of customers.

### Second Embodiment

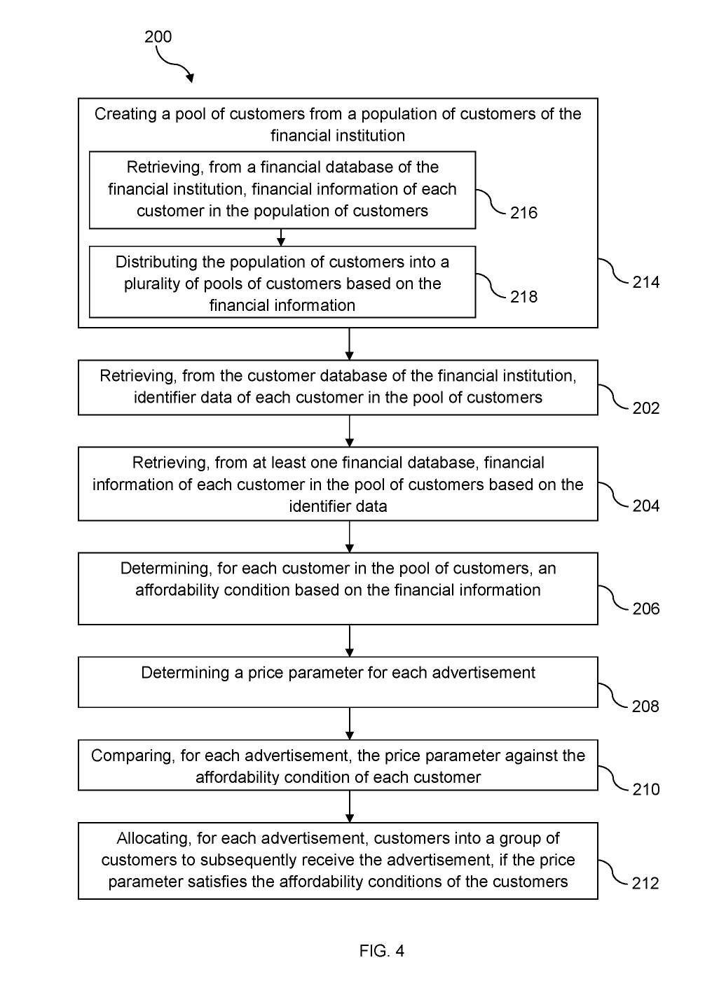

In a second embodiment which is described with reference to FIG. 4, the computing system 100 of a financial institution 30 is configured or operative for performing the method 200 of grouping of customers of the financial institution 30 to subsequently receive advertisements. The customers are grouped from a pool of customers of the financial institution 30. In addition, the method 200 comprises a step 214 of creating the pool of customers, such as by the customer distribution module 114 or other module/component of the computing system 100, from a population of customers of the financial institution 30 prior to performing the step 202.

The step 214 of creating the pool of customers comprises a step 216 of retrieving, such as by data collection module 104 or other module/component of the computing system 100, and from the financial database 34 of the financial institution 30, financial information of each customer in the population of customers. It may be appreciated that the financial information retrieved from the financial database 34 refers to institution-specific financial information, i.e. financial information that is specific or relevant to the business relationship between a customer and the financial institution 30 only. For example, the financial information may include data on outstanding debt that the customer owes to the financial institution 30, and current credit/debit data between the customer and the financial institution 30. The financial information may also indicate the outstanding amount on the customer's credit card issued by the financial institution 30. The financial information may also comprise historical transaction data of the customer, and the historical transaction data may be derived from past transactions between the customer and the financial institution 30.

The step 214 of creating the pool of customers further comprises a step 218 of distributing, such as by the customer distribution module 114 or other module/component of the computing system 100, the population of customers into a plurality of pools of customers based on the financial information. Each pool of customers may have different qualifying criteria and a customer may be allocated into a pool based on whether the customer's financial information fulfills the qualifying criteria. For each pool of customers, the method 200 is performed for grouping of customers within the pool of customers to subsequently receive advertisements.

The step 218 of distributing the population of customers may further comprise determining, such as by the customer distribution module 114 or other module/component of the computing system 100, and for each customer in the population of customers, an average credit balance and a profitability estimate based on the financial information. From the financial information, the financial institution 30 would be able to determine the average credit balance of each customer, such as the monthly credit balance (i.e. amount available for spending) averaged across 12 months. Similarly, based on past transaction data such as purchases made by each customer with credit cards issued by the financial institution 30 and fees paid by each customer to the financial institution 30, the financial institution 30 would be able to estimate the profitability of the business relationship between each customer and the financial institution 30. The profitability estimate is an indication as to how much profit the financial institution 30 can earn from a customer, e.g. over a one year period. It may be appreciated that a profitability estimate for a customer may be in the form of a percentage score, such as a profit percentage based on the cost of the business relationship between the customer and the financial institution 30.

The step 218 of distributing the population of customers into the plurality of pools of customers may be based on the average credit balances and profitability estimates. In one example, in the customer distribution module 114 or other module/component of the computing system 100, the population of customers may firstly be distributed to a plurality of balance groups based on the average credit balances, and secondly for each balance group, customers in the balance group may be distributed to a plurality of profitability groups based on the profitability estimates. In another example, the balance groups and profitability estimates may exchange places. Specifically, in the customer distribution module 114 or other module/component of the computing system 100, the population of customers may firstly be distributed to a plurality of profitability groups based on the profitability estimates, and secondly for each profitability group, customers in the profitability group may be distributed to a plurality of balance groups based on the average credit balances.

The distribution of the population of customers may be illustrated in a table format, wherein each row represents a balance group or profitability group, and each column represents a profitability group or balance group, respectively. Accordingly, each cell in the table represents a pool of customers, such that each pool of customers is defined by one profitability group and one balance group. It may be appreciated that each customer in the population of customers is allocated to one of the plurality of pools of customers, such that each pool of customer represents a subset or portion of the population of customers. Each pool of customers may then be distributed into a plurality of groups of customers for receiving advertisements.

The framework of considering the affordability conditions of customers and the price parameters of advertisements may thus be implemented or integrated together with another advertising or targeting strategy of the financial institution 30, e.g. with consideration of the customers' average credit balance and profitability estimates. This may further improvise the advertising or targeting strategy and provide better prospects to receive the advertisements.

A detailed example of the second embodiment described above with reference to FIG. 4 is described in Example 2 below.

### EXAMPLE 2

In this example, a population of customers of a financial institution 30 may consist of 1,000 customers. The institution-specific financial information of each customer is retrieved according to the step 216 of the method 200. The average credit balances and profitability estimates of each customer can be determined based on the financial information. Further, from the average credit balances and profitability estimates, each customer is allocated to a pool of customers defined by one balance group and one profitability group. The pool(s) of customers is created according to the step 214 of the method 200. Table 5 below illustrates an example of such a distribution of the population of customers.

TABLE 5

| | Balance Group | | | | |
|---|---|---|---|---|---|
| | | BG2 ($2,000 | BG3 ($4,000 | BG4 ($6,000 | |
| Profitability | BG1 (below | to below | to below | to below | BG5 ($8,000 |
| Group | $2,000) | $4,000) | $6,000) | $8,000) | and above) |
| PG1 (below | 80 | 40 | 20 | 10 | 0 |
| 10%) | | | | | |
| PG2 (10% to | 50 | 90 | 70 | 40 | 10 |
| below 30%) | | | | | |
| PG3 (30% to | 150 | 90 | 80 | 40 | 10 |
| below 50%) | | | | | |
| PG4 (50% to | 20 | 20 | 40 | 30 | 20 |
| below 70%) | | | | | |
| PG5 (70% and | 0 | 10 | 40 | 30 | 10 |
| above) | | | | | |

For customers with different average credit balances/profitability estimates that differ slightly, the customers may be grouped together within the same balance group/profitability group. For example, in the balance group BG2,there may be customers with average credit balances of $2,100, $2,500, $3,500, $3,700, and $3,950. These customers are grouped together in the same balance group BG2. Similarly, in the profitability group PG2, there may be customers with profitability estimates of 12%, 15%, 20%, 25%, and 28%. These customers are grouped together in the same profitability group PG2. The balance groups and profitability groups thus provide for broader segregation of the population of customers based on their financial information, specifically the average credit balances and profitability estimates.

In Table 5, each cell represents a pool of customers defined by one profitability group and one balance group. Each customer may be assigned to one pool of customers. After forming or creating the plurality of pools of customers, the method 200 is performed for each pool of customers. The performance of the method 200 for each pool of customers is substantially similar or analogous to Example 1. It would be appreciated that the various aspects/features / elements of Example 1 may apply similarly or analogously to Example 2. For purpose of brevity, such similar or analogous aspects/features/elements are not further elaborated upon. After grouping of customers within each pool of customers according to the method 200, the advertisements may be subsequently communicated to the respective groups of customers.

In the foregoing detailed description, embodiments of the present disclosure in relation to a method and system for grouping of customers to subsequently receive advertisements are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A computerized method implemented on a computing system of a financial institution for grouping of customers from a pool of customers of the financial institution to subsequently receive advertisements, the method comprising:
retrieving, by a data collection module of the computing system and from a customer database of the financial institution, identifier data of each customer in the pool of customers;
retrieving, by the data collection module and from at least one financial database, financial information of each customer in the pool of customers based on the identifier data;
determining, by an affordability condition determination module of the computing system and for each customer in the pool of customers, an affordability condition based on the financial information;
determining, by a price parameter determination module of the computing system, a price parameter for each advertisement;
comparing, by an advertisement comparison module of the computing system and for each advertisement, the price parameter against the affordability condition of each customer; and
allocating, by a customer allocation module of the computing system and for each advertisement, customers into a group of customers to subsequently receive the advertisement, if the price parameter satisfies the affordability conditions of the customers.

2. The method according to claim 1, further comprising allocating, by the customer allocation module, customers into a second group of customers after being allocated into a first group of customers to subsequently receive the advertisements associated with the first and second groups of customers, if the price parameters of the advertisements satisfy the affordability conditions of the customers.

3. The method according to claim 2, wherein the customers are allocated into one of the first and second groups of customers based on the advertisement with the highest price parameter.

4. The method according to claim 1, wherein the affordability condition of each customer represents a price range or a price point.

5. The method according to claim 1, wherein the price parameter of each advertisement represents a price range or a price point.

6. The method according to claim 1, wherein retrieving the financial information of each customer in the pool of customers from at least one financial database comprises retrieving consolidated financial information of each customer from a credit bureau database.

7. The method according to claim 6, wherein the consolidated financial information of each customer is aggregated from multiple financial sources associated with the customer.

8. The method according to claim 1, further comprising creating the pool of customers from a population of customers of the financial institution prior to retrieving the identifier data.

9. The method according to claim 1, wherein creating the pool of customers further comprises distributing, by a customer distribution module, the population of customers into a plurality of pools of customers based on the financial information.

10. The method according to claim 9, wherein distributing the population of customers into the plurality of pools of customers is based on average credit balances and profitability estimates determined from the financial information.

11. A computing system for grouping of customers from a pool of customers of a financial institution to subsequently receive advertisements, the computing system comprising: a computer processor and a data storage device, the data storage device having a data collection module; an affordability condition determination module; a price parameter determination module; an advertisement comparison module and a customer allocation module comprising non-transitory instructions operative by the processor to:
retrieve, from a customer database of the financial institution, identifier data of each customer in the pool of customers; and
retrieve, from at least one financial database, financial information of each customer in the pool of customers based on the identifier data;
determine, for each customer in the pool of customers, an affordability condition based on the financial information;
determine a price parameter for each advertisement;
compare, for each advertisement, the price parameter against the affordability condition of each customer; and
allocate, for each advertisement, customers into a group of customers to subsequently receive the advertisement, if the price parameter satisfies the affordability conditions of the customers.

12. The computing system according to claim 11, the customer allocation module further comprising non-transitory instructions operative by the processor to:
allocate customers into a second group of customers after being allocated into a first group of customers to subsequently receive the advertisements associated with the first and second groups of customers, if the price parameters of the advertisements satisfy the affordability conditions of the customers.

13. The computing system according to claim 12, wherein the customers are allocated into one of the first and second groups of customers based on the advertisement with the highest price parameter.

14. The computing system according to claim 11, wherein the affordability condition of each customer represents a price range or a price point.

15. The computing system according to claim 11, wherein the price parameter of each advertisement represents a price range or a price point.

16. The computing system according to claim 11, the data collection module further comprising non-transitory instructions operative by the processor to:
retrieve consolidated financial information of each customer from a credit bureau database during the step of retrieving the financial information of each customer in the pool of customers from at least one financial database.

17. The computing system according to claim 16, wherein the consolidated financial information of each customer is aggregated from multiple financial sources associated with the customer.

18. The computing system according to claim 11, the data storage device further comprising a customer distribution module comprising non-transitory instructions operative by the processor to:
create the pool of customers from a population of customers of the financial institution prior to retrieving the identifier data.

19. The computing system according to claim 11, the customer distribution module further comprising non-transitory instructions operative by the processor to:
distribute the population of customers into a plurality of pools of customers based on the financial information during the step of creating the pool of customers.

20. The computing system according to claim 19, wherein the customer distribution module further comprises non-transitory instructions operative by the processor to: distribute the population of customers into the plurality of pools of customers based on average credit balances and profitability estimates determined from the financial information.

21. A non-transitory computer-readable medium storing computer-readable instructions for grouping customers from a pool of customers of a financial institution to subsequently receive advertisements, the computer-readable instructions, when executed, cause a processor to:
retrieve, from a customer database of the financial institution, identifier data of each customer in the pool of customers; and
retrieve, from at least one financial database, financial information of each customer in the pool of customers based on the identifier data;
determine, for each customer in the pool of customers, an affordability condition based on the financial information;
determine a price parameter for each advertisement;
compare, for each advertisement, the price parameter against the affordability condition of each customer; and
allocate, for each advertisement, customers into a group of customers to subsequently receive the advertisement, if the price parameter satisfies the affordability conditions of the customers.
